(19) United States
(12) Patent Application Publication
(10) Pub. No.: US 2005/0079443 A1
(43) Pub. Date: Apr. 14, 2005

(54) Radiation-sensitive polymer composition and pattern forming method using the same

(75) Inventors: Kazumi Noda, Naka Kubiki-gun (JP); Katsuya Takemura, Naka Kubiki-gun (JP); Yoshitaka Hamada, Naka Kubiki-gun (JP); Mutsuo Nakashima, Naka Kubiki-gun (JP)

Correspondence Address: FOLEY AND LARDNER;SUITE 500, 3000 K STREET NW, WASHINGTON, DC, 20007, US

(73) Assignee: SHIN-ETSU CHEMICAL CO., LTD.

(21) Appl. No.: 10/959,200

(22) Filed: Oct. 7, 2004

(30) Foreign Application Priority Data
Oct. 7, 2003 (JP) 2003-347709

(51) Int. Cl. G03C 1/76

(52) U.S. Cl. 430/270.1

(57) ABSTRACT

Provided is a silicon-containing positive photoresist which exhibits high resolution capacity when exposed to radiation having a wavelength of 300 nm or less, especially KrF (248 nm) or ArF (193 nm), which has excellent dry etching resistance and which can be developed with an aqueous alkali solution. Provided is a radiation sensitive polymer composition comprising (A) a polysiloxane compound which comprises at least one structural unit represented by formula (1) having an acid-dissociable group, and at least one structural unit represented by formula (2) comprising at least one fluorine atom; which is alkali insoluble or alkali sparingly soluble but becomes alkali soluble when the acid-dissociable group dissociates; and which has an average fluorine atom content of more than 2 wt % but not more than 11 wt %; (B) an acid generator; and (C) a basic compound.

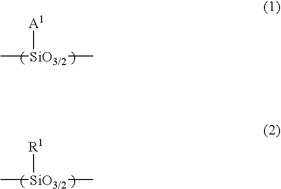

### CROSS-REFERENCE TO RELATED APPLICATIONS

The present application claims priorities to Japanese Patent Application No. 2003-347709, filed Oct. 7, 2003, the disclosure of which is incorporated herein by reference in its entirely.

### BACKGROUND OF THE INVENTION

1. Field of the Invention

The invention relates to a positive photoresist which can be used as an upper writing layer in a two-layer film process or as a drawing layer in a monolayer film process. More specifically, the invention relates to a positive photoresist for lithography by deep ultraviolet rays (DUV), X rays or electron beam, wherein the photoresist exhibits high resolution capacity and excellent dry etching resistance, and can be developed with an aqueous alkali solution.

2. Description of the Related Art

As semiconductor devices have a microstructure, resist materials have been demanded to have various improved properties such as higher resolution, wider process window, and better etching resistance. Improvements in resolution and process margin have so far been pursued by optimizing a resist composition, shortening the wavelength of an exposure light source and thinning of a resist film. Thinning of a resist film is effective for increasing the absorption of light by the shortened wavelength of an exposure light source and for relaxing a rise in the aspect ratio of a resist pattern which occurs with a trend toward finer processing. In a step of a next generation device for which fine processing is required, however, it has been pointed out that there is a fear of failing to maintain sufficient etching resistance in a system which adopts a conventional material. As a method for thinning a film while maintaining etching resistance, a multilayer process using a silicon-containing resist has been investigated. A number of compositions have been reported and among them, a resist composition containing a ladder-like polyorganosilsesquioxane is known to have high plasma resistance.

For example, in Japanese Patent Application Unexamined Publication No. 10-324748/1998 or 11-302382/1999, disclosed are a siloxane polymer having, in the side chain thereof, a non-aromatic monocyclic or polycyclic hydrocarbon or crosslinked cyclic hydrocarbon group having a carboxyl group wherein at least a portion of the carboxyl group has been substituted by an acid-labile group; and a resist material comprising the polymer. The siloxane polymer includes a siloxane polymer having, at the 5-position thereof, a t-butoxycaarbonyl group and having a silicon atom to which a norbornyl group has been bonded. The resist material has low absorption at the exposure wavelength of KrF excimer laser (wavelength: 248 nm) or ArF excimer laser (wavelength: 193 nm), permits formation of good pattern shape, and has excellent sensitivity, resolution and dry etching resistance. It is reported in Japanese Patent Application Unexamined Publication No. 2002-055456 or 2002-268227 that a silicone-containing polymer having a fluorinated alcohol introduced therein has particularly low absorption at an exposure wavelength of F₂ excimer laser and exhibits excellent sensitivity, resolution and plasma etching resistance. Various compositions as described above comprising a fluorine-containing siloxane polymer having low absorption at an exposure wavelength of F₂ excimer laser (157 nm) have been reported for use in the process aiming at improvement of resolution by shortening the wavelength of the exposure light source. For example, in Japanese Patent Application Unexamined Publication No. 2002-220471, it is reported that a radiation functional polymer composition comprising polysiloxane having a silicon atom to which a specific acid-dissociable group has been bonded via at least two bicyclo[2.2.1]heptane rings is useful because of excellent dry etching resistance and high transparency to radiation not greater than 157 nm. Also in Japanese Patent Application Unexamined Publication Nos. 2002-278073, 2003-20335 and 2003-173027, it is reported that a radiation functional polymer composition comprising a fluorine-containing polysiloxane is useful because of high transparency to radiation not greater than 157 nm. As a method for improving resolution by reducing the film thickness of a material, it is reported in Japanese Patent Application Unexamined Publication No. 2001-215714 that when a silicon-containing polymer having a specific range of viscosity is used, a resist film can be thinned further while maintaining the in-plane evenness thereof. There is, however, a fear of failing to maintain sufficient etching resistance for next generation devices requiring micro-processing in a semiconductor manufacturing process when thinning of a resist film is promoted in order to attain further micro-processing by using an existing equipment. It is therefore urgent to develop a resist material having better etching resistance.

### SUMMARY OF THE INVENTION

The invention has been accomplished to satisfy the above-described demand and its object is to provide a silicon-containing positive photoresist exhibiting high resolution when exposed to radiation having a wavelength of 300 nm or less, especially to KrF (248 nm) or ArF (193 nm), has excellent dry etching resistance, and can be developed with an aqueous alkali solution.

As a result of extensive investigation with a view to attain the above-described object, the inventors have found that when a polysiloxane compound containing a certain range of fluorine within a specific range is used as a polymer, an underlying film for processing showing excellent dry etching resistance can be formed. Based on this finding, this application has been filed. The invention therefore provides the below-described resist pattern forming material and resist pattern forming method.

Described specifically, in the invention, there is thus provided a radiation sensitive polymer composition comprising
(A) a polysiloxane compound which comprises at least one structural unit represented by formula (1) having an acid-dissociable group which leaves in the presence of an acid and at least one structural unit represented by formula (2) comprising at least one fluorine atom; which is alkali insoluble or alkali sparingly soluble but becomes alkali soluble as the acid-dissociable group leaves; and which has an average fluorine atom content of greater than 2 wt % but not greater than 11 wt %;
(B) an acid generator, and
(C) a basic compound,
   wherein the formulas (1) and (2) are represented by: 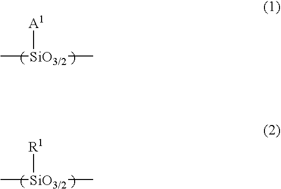
   wherein A¹ represents a monovalent organic group comprising an acid-dissociable group which leaves in the presence of an acid; and R¹ represents a linear, branched or cyclic C₁₋₂₀ alkyl group comprising at least one fluorine atom, or a linear, branched or cyclic halogenated C₁₋₂₀ alkyl group comprising at least one fluorine atom and at least one halogen atom other than the fluorine atom.

In another aspect of the invention, there is also provided a method for forming a resist pattern, comprising steps of applying the radiation sensitive polymer composition onto a substrate to form a film, heating the film, exposing the heated film to radiation having a wavelength of from 170 to 300 nm through a photo mask, optionally heating the exposed film, and developing the film with a developer.

Since the composition of the invention is effectively sensitive to radiation such as deep ultraviolet rays, has excellent sensitivity and resolution upon pattern formation using radiation having a wavelength of from 170 to 300 nm, and has excellent dry etching resistance, it is a promising material in the fine processing of an underlying film.

### BRIEF DESCRIPTION OF THE DRAWINGS

FIG. 1 illustrates the relationship between the fluorine atom content and etching rate of a radiation sensitive polymer composition.

### DETAILED DESCRIPTION OF THE PREFERRED EMBODIMENTS

The invention will next be described more specifically.

The polymer serving as Component (A) in the invention is an alkali insoluble or alkali sparingly soluble polysiloxane compound containing an acid-dissociable group. The polysiloxane compound becomes alkali soluble as the acid-dissociable group leaves. It comprises at least one structural unit represented by formula (1) and at least one structural unit represented by formula (2).

The term “alkali insoluble or alkali sparingly soluble” means that the solubility in a 2.38 wt % aqueous solution of TMAH (tetramethylammonium hydroxide) is less than 0 to 2 nm (0 to 20 Å)/sec, while the term “alkali soluble” means that said solubility is from 2 to 30 nm (20 to 300 Å)/sec.

In formula (1), A¹ represents a monovalent organic group comprising an acid-dissociable group and may preferably includes norbornene having a carboxylate ester as a substituent.

The structural unit represented by formula (1) may include a variety of units and preferably those represented by formula (3): 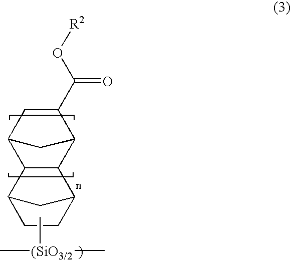
wherein R² represents an acid-dissociable group and n stands for an integer of 0 or 1.

In the repeating unit represented by formula (3), the R² which represents an acid-dissociable group may include various groups and be preferably one or more groups selected from the group consisting of C₄₋₂₀ tertiary alkyl groups represented by formula (5), C₁₋₆ trialkylsilyl groups and C₄₋₂₀ oxoalkyl groups.

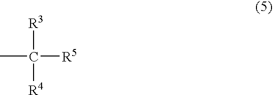

In formula (5), R³, R⁴ and R⁵ each independently represents a linear, branched or cyclic monovalent C₁₋₂₀ alkyl group. The R³ and R⁴, R³ and R⁵, or R⁴ and R⁵ may be coupled to form a C₃₋₂₀ ring together with the carbon atom to which these groups are bonded.

Specific examples of the tertiary alkyl group represented by the formula (5) may include tert-butyl, triethylcarbyl, 1-ethylnorbornyl, 1-methylcyclohexyl, 1-ethylcyclopentyl, 2-(2-ethyl)adamantyl and tert-amyl groups.

Examples of the trialkylsilyl group may include those with each alkyl having 1 to 6 carbons such as trimethylsilyl, triethylsilyl and dimethyl-tert-butylsilyl groups.

Examples of the C₄₋₂₀ oxoalkyl group may include 3-oxocyclohexyl group and groups represented by the following formulas:

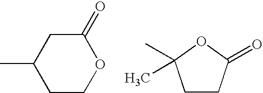

In the repeating unit represented by formula (3), a structure which does not cause lowering in a silicon content of the compound can be selected in order to maintain better etching resistance. A structural unit of formula (3) may be preferably the unit having a bicyclo[2.2.1]heptane ring in which n stands for 0.

As the structural unit of formula (2) containing a fluorine atom, the structural unit represented by formula (4) may be especially preferred.

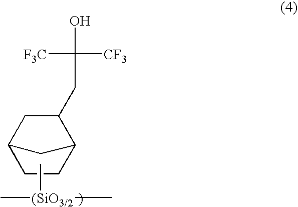

The structural unit represented by formula (4) contains, as a substituent thereof, hexafluoroalcohol which is known to exhibit high solubility in an alkali developer. It is known that this structural unit can be used for improving alkali solubility, transparency and adhesion.

When the content of this structural unit is increased for improvement of resolution, however, dry etching resistance may lower owing to an increase in the fluorine content in the polymer, which may disturb the resulting photoresist to have dry etching resistance enough for a desired two-layer resist process.

Thus, according to the invention, the composition comprising a polymer having an average fluorine atom content exceeding 2 wt % but not greater than 11 wt % is used. Especially, the polymer having an average fluorine atom content of 4 wt % to 10 wt % may be preferred. When the fluorine atom content exceeds 11 wt %, the resistance of the photoresist may become insufficient for the processing of an underlying film owing to lowering in the dry etching resistance. When the fluorine atom content is less than 2 wt %, the dissolution rate of the resulting resist film lowers so that pattern formation may become difficult.

The polysiloxane compound of the invention may further comprise one or more other structural units, in addition to the structural units of (1) and (2), for the purpose of improving alkali solubility, transparency and adhesion.

As the other structural units, a structure containing a silicon atom to which three oxygen atoms are bonded may be preferably selected in order not to deteriorate the solubility in a solvent and in order not to impair the condensation degree of siloxane. For example, structural unit represented by formula (6) below can be provided. To prevent deterioration in various properties such as resolution and solubility in an ordinarily employed resist solvent, the structural unit containing a structure in which a hydrocarbon group with a norbornane skeleton has been bonded to a silicon atom, which structure is analogous to the structure of the formula (3), may be especially preferred.

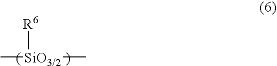

Herein, R⁶ represents a linear, branched or cyclic C₁₋₂₀ hydrocarbon group which may be substituted and may contain one or more selected from the group consisting of a hydroxyl group, an ether group, an ester group and a lactone ring.

In the polysiloxane compound as Component (A) of the invention, the content of each of the structural unit represented by formula (1), the structural unit represented by formula (2) and the other structural unit can be determined as needed in consideration of the oxygen plasma etching resistance, sensitivity, resistance against cracking of patterns, substrate adhesion and resist profile which a resist is desired to have, as well as in consideration of resolution and heat resistance which are usually required for a resist, within an extent not disturbing the advantages of the invention.

Usually, in the polysiloxane compound serving as Component (A) in the invention, the content of the structural unit represented by formula (1) may be preferably from 10 to 90 mole %, more preferably from 15 to 80 mole % based on all the structural units.

The content of the structural unit represented by formula (2) may be determined so that the average fluorine content based on all the structural units will be 2 wt % or greater but not greater than 11 wt %. Upon determination, the resist film thickness and dry etching resistance necessary for a desired process are also considered. The structural unit having an average fluorine content of from 4 wt % to 10 wt % may be especially preferred. When the fluorine content exceeds 11 wt %, lowering in dry etching resistance may prevent the resulting resist film from having resistance enough for the processing of the underlying film. When the fluorine content is less than 2 wt %, the dissolution rate of the resulting resist film is lowered so that the pattern formation may become difficult.

The content of the other structural unit such as one represented by formula (6) may be usually from 0 to 90 mole %, preferably from 15 to 70 mole %, more preferably from 20 to 60 mole % based on all the repeating units.

The polysiloxane compound serving as Component (A) may be obtained by polycondensation of an alkoxysilane or trichlorosilane monomer corresponding to the structural unit of formula (1), an alkoxysilane or trichlorosilane monomer corresponding to the structural unit of formula (2), and optionally an alkoxysilane or trichlorosilane monomer corresponding to the other structural unit, or partially condensed products of these silane compounds in the presence of a catalyst in a conventional manner. Conventional reaction solvent and catalyst can be employed.

The polysiloxane compound of the invention may have a weight-average molecular weight of from 500 to 100,000, more preferably from 1,000 to 30,0000 as measured with GPC (gel permeation chromatography) using polystyrene as a standard. When the weight-average molecular weight is less than 500, deterioration in heat resistance or dry etching resistance may occur. When the weight-average molecular weight is more than 100,000, deterioration in developing property or solubility of the resulting polymer in a solvent may occur.

Component (B) in the invention is a radiation sensitive acid generator which generates an acid by exposure. The acid generator (B) eliminates, from the polysiloxane compound (A), the acid-dissociable group through the action of the acid generated by exposure, whereby the exposed portion of the resist film becomes easily soluble in an alkali developer. Thus, the acid generator has an action of forming a positive resist pattern.

The acid generator may be selected from conventional acid generators. Specific examples may include onium salt acid generators, halogen-containing compound acid generators, sulfonic acid compound acid generators and sulfonate compound acid generators.

Examples of the onium salt acid generators may include diphenyliodonium trifluoromethanesulfonate, diphenyliodonium pyrenesulfonate, diphenyliodonium dodecylbenzenesulfonate, diphenyliodonium nonafluoro-n-butanesulfonate, bis(4-t-butylphenyl)iodonium trifluoromethanesulfonate, bis(4-t-butylphenyl)iodonium dodecylbenzenesulfonate, bis(4-t-butylphenyl)iodonium naphthalenesulfonate, bis(4-t-butylphenyl)iodonium hexafluoroantimonate, bis(4-t-butylphenyl)iodonium nonafluoro-n-butanesulfonate, triphenylsulfonium trifluoromethanesulfonate, triphenylsulfonium hexafluoroantimonate, triphenylsulfonium naphthalenesulfonate, triphenylsulfonium nonafluoro-n-butanesulfonate, triphenylsulfonium perfluoro-n-octanesulfonate, (hydroxyphenyl)benzenemethylsulfonium toluenesulfonate, cyclohexylmethyl(2-oxocyclohexyl)sulfonium trifluoromethanesulfonate, dicyclohexyl(2-oxocyclohexyl)sulfonium trifluoromethanesulfonate, dimethyl(2-oxocyclohexyl)sulfonium trifluoromethanesulfonate, diphenyliodonium hexafluoroantimonate, triphenylsulfonium camphorsulfonate, (4-hydroxyphenyl)benzylmethylsulfononium toluenesulfonate, 1-naphthyldimethylsulfonium trifluoromethanesulfonate, 1-naphthyldiethylsulfonium trifluoromethanesulfonate, 4-cyano-1-naphthyldimethylsulfonium trifluoromethanesulfonate, 4-nitro-1-naphthyldimethylsulfonium trifluoromethanesulfonate, 4-methyl-1-naphthyldimethysulfonium trifluoromethanesulfonate, 4-cyano-1-naphthyl-diethylsulfonium trifluoromethanesulfonate, 4-nitro-1-naphthyldiethylsulfonium trifluoromethanesulfonate, 4-methyl-1-naphthyldiethylsulfonium trifluoromethanesulfonate, 4-hydroxy-1-naphthyldimethylsulfonium trifluoromethanesulfonate, 4-hydroxy-1-naphthyltetrahydrothiophenium trifluoromethanesulfonate, 4-methoxy-1-naphthyletrahydrothiophenium trifluoromethanesulfonate, 4-ethoxy-1-naphthyltetrahydrothiophenium trifluoromethanesulfonate, 4-methoxymethoxy-1-naphthyltetrahydrothiophenium trifluoromethanesulfonate, 4-ethoxymethoxy-1-naphthyltetrahydrothiophenium trifluoromethanesulfonate, 4-(1-methoxyethoxy)-1-naphthyltetrahydrothiophenium trifluoromethanesulfonate, 4-(2-methoxyethoxy)-1-naphthyltetrahydrothiophenium trifluoromethanesulfonate, 4-methoxycarbonyloxy-1-naphthyltetrahydrothiophenium trifluoromethanesulfonate, 4-ethoxycarbonyloxy-1-naphthyltetrahydrothiophenium trifluoromethanesulfonate, 4-n-propoxycarbonyloxy-1-naphthyltetrahydrothiophenium trifluoromethanesulfonate, 4-i-propoxycarbonyloxy-1-naphthyltetrahydrothiophenium trifluoromethanesulfonate, 4-n-butoxycarbonyloxy-1-naphthyltetrahydrothiophenium trifluoromethanesulfonate, 4-t-butoxycarbonyloxy-1-naphthyltetrahydrothiophenium trifluoromethanesulfonate, 4-(2-tetrahydrofuranyloxy)-1-naphthyltetrahydrothiophenium trifluoromethanesulfonate, 4-(2-tetrahydropyranyloxy)-1-naphthyltetrahydrothiophenium trifluoromethanesulfonate, 4-benzyloxy-1-naphthyltetrahydrothiophenium trifluoromethanesulfonate and 1-(naphthylacetomethyl)tetrahydrothiophenium trifluoromethanesulfonate.

Examples of the halogen-containing compound acid generators may include phenyl-bis(trichloromethyl)-s-triazine, methoxyphenyl-bis(trichloromethyl)-s-triazine and naphthyl-bis(trichloromethyl)-2-triazine.

Examples of the sulfonic acid compound acid generators may include 4-trisphenacylsulfone, mesitylphenacylsulfone and bis(phenylsulfonyl)methane.

Examples of the sulfonate compound acid generators may include benzoin tosylate, tris-trifluoromethanesulfonate of pyrogallol, nitrobenzyl-9,10-diethoxyanthracene-2-sulfonate, trifluoromethanesulfonylbicyclo[2.2.1]hept-5-en-2,3-dicarbodiimide, N-hydroxysuccinimide trifluoromethanesulfonate and 1,8-naphthalenedicarboxylic acid imidotrifluoromethanesulfonate.

Examples of the particularly preferred acid generators may include diphenyliodonium trifluoromethanesulfonate, diphenyliodonium nonafluoro-n-butanesulfonate, diphenyliodonium 10-camphorsulfonate, bis(4-t-butylphenyl)iodonium trifluoromethanesulfonate, bis(4-t-butylephenyl)iodonium nonafluoro-n-butanesulfonate, bis(4-t-butylephenyl)iodnium camphorsulfonate, triphenylsulfonium trifluoromethanesulfonate, triphenylsulfonium nonafluoro-n-butanesulfonate and triphenylsulfonium 10-camphorsulfonate.

According to the invention, the acid generator (B) may be used singly or as a mixture of two or more of them. The acid generator (B) may be typically added in an amount of from 0.5 to 19 parts by weight, preferably from 1 to 10 parts by weight, based on 100 parts by weight of the polysiloxane (A). When the amount is less than 0.5 part by weight, sensitivity and developing properties may lower. When the amount exceeds 19 parts by weight, the resist material may have resolution reduced and have heat resistance lowered because of the excessive monomer component.

According to the invention, the basic compound of Component (C) may be preferably a compound capable of suppressing excessive diffusion of an acid, which has been generated by an acid generator, into a resist film. Addition of the basic compound can be effective for correcting the pattern shape or improving shelf life.

The basic compound may typically include a nitrogenous organic compound having a molecular weight of 1000 or less.

Examples may include mono(cyclo)alkylamines such as n-hexylamine, n-hepthylamine, n-octylamine, n-nonylamine, n-decylamine and cyclohexylamine; di(cyclo)alkylamines such as di-n-butylamine, di-n-pentylamine, di-n-hexylamine, di-n-heptylamine, di-n-octylamine, di-n-nonylamine, di-n-decylamine, cyclohexylmethylamine and dicyclohexylamine; tri(cyclo)alkylamines such as triethylamine, tri-n-propylamine, tri-n-butylamine, tri-n-pentylamine, tri-n-hexylamine, tri-n-heptylamine, tri-n-octylamine, tri-n-nonylamine, nonylamine, tri-n-decylamine, monoethanolamine, diethanolamine, triethanolamine, triisopropanolamine, 3-amino-1-propanol, 2,2-bis(hydroxymethyl)-2,2′,2″-nitrilotriethanol, cyclohexyldimethylamine, methyldicylohexylamine and tricyclohexylamine; aromatic amines such as aniline, N-methylaniline, N,N-dimethylaniline, 2-methylaniline, 3-methylaniline, 4-methylaniline, 4-nitroaniline diphenylamine, triphenylamine and naphthylamine; amines such as ethylenediamine, N,N,N′,N′-tetramethylethyenediamine, tetramethylenediamine, hexamethylenediamine, 4,4′-diaminodiphenylmethane, 4,4′-diaminodiphenylether, 4,4′-diaminobenzophenone, 4,4′-diaminodiphenylamine, 2,2-bis(4-aminophenyl)propane, 2-(3-aminophenyl)-2-(4-aminophenyl)propane, 2-(4-aminophenyl)-2-(3-hydroxyphenyl)propane, 2-(4-aminophenyl)-2-(4-hydroxyphenyl)propane, 1,4-bis[1-(4-aminophenyl)-1-methylethyl]benzene, 1,3-bis[1-(4-aminophenyl)-1-methylethyl]benzene, bis(2-dimethylaminoethyl)ether and bis(2-diethylaminoethyl)ether; amide-containing compounds such as formamide, N-methylformamide, N,N-dimethylformamide, acetamide, N-methylacetamide, N,N-dimethylacetamide, propionamide, benzamide, pyrrolidone and N-methylpyrrolidone; imidazoles such as imidazole, benzimidazole, 4-methylimidazole, 4-methyl-2-phenylimidazole and N-t-butoxycarbonyl-2-phenylbenzimidazole; pyridines such as pyridine, 2-methylpyridine, 4-methylpyridine, 2-ethylpyridine, 4-ethylpyridine, 2-phenylpyridine, 4-phenylpyridine, 2-methyl-4-phenylpyridine, nicotine, nicotinic acid, nicotinic acid amide, quinoline, 4-hydroxyquinoline, 8-oxyquinoline, and acridine; pyperazines such as pyperazine and 1-(2-hydroxyethyl)pyperazine; and nitrogenous heterocyclic compounds such as pyrazine, pyrazole, pyridazine, quinazoline, purine, pyrrolidine, piperidine, 3-piperidino-1,2-propanediol, morpholine, 4-methylmorpholine, 1,4-dimethylpiperazine and 1,4-diazabicyclo[2.2.2]octane. Aliphatic amines may be especially preferred.

The basic compound of Component (C) may be used singly or as a mixture of two or more of them. The basic compound may be typically added in an amount of from 0.001 to 2 parts by weight, preferably from 0.01 to 1 part by weight, based on 100 parts by weight of Component (A). When the amount of the basic compound is less than 0.001 part by weight, it may not bring about any effect. When the amount is more than 2 parts by weight, the sensitivity of the resulting resist may unduly lower.

The above-described resist composition may be obtained only by dissolving each component in an organic solvent. The organic solvent may be preferably a solvent capable of sufficiently dissolving therein each component and permitting uniform spreading of the resist film. Specific examples may include ketones such as cyclohexanone, cyclopentanone, 2-heptanone, 3-heptanone and 4-heptanone; alcohols such as 3-methoxybutanol, 3-methyl-3-methoxybutanol, 1-methoxy-2-propanol and 1-ethoxy-2-propanol; ethers such as propylene glycol monomethyl ether, ethylene glycol monomethyl ether, propylene glycol monoethyl ether, propylene glycol dimethyl ether, diethylene glycol dimethyl ether, ethylene glycol tert-butyl ether methyl ether (1-tert-butoxy-2-methoxyethane) and ethylene glycol tert-butyl ether ethyl ether (1-tert-butoxy-2-ethoxyethane); and esters such as propylene glycol monomethyl ether acetate, propylene glycol monoethyl ether acetate, ethyl lactate, ethyl pyruvate, butyl acetate, methyl 3-methoxypropionate, ethyl 3-ethoxypropionate, tert-butyl acetate, tert-butyl propionate and methyl β-methoxyisobutyrate. Of these, propylene glycol monomethyl ether acetate (α, β) may be preferred because of the excellent solubility of resist components therein and safety. The organic solvent may be used singly or in combination of two or more of them. The solvent may be typically added in an amount of from 400 to 5000 parts by weight, preferably from 700 to 2000 parts by weight, based on 100 parts by weight of Component (A).

The resist material of the invention may optionally comprise an ordinarily used additive such as a surfactant in addition to the above-described components. The optional component may be comprised in a usual amount within an extent not impairing the advantages of the invention.

Examples of the surfactant may include fluorine-containing surfactants and silicon-containing surfactants such as “Florad FC430, 431” (each, product of Sumitomo 3M Limited), “Megafac F171, F173, F176, F189, R08” (each, product of Dainippon Ink & Chemicals Inc.), “Surflon S-382, SC101, 102, 103, 104, 105 and 106” (each, product of Asahi Glass Co., Ltd.) and “X-70-092” and “X-70-093” (each, product of Shin-Etsu Chemical Co., Ltd.).

In addition to the above-described additive, a halation preventive agent, an adhesion aid, a storage stabilizer or a defoaming agent may be comprised.

A method for forming the patterns by using the above-described resist material may include known technology. For example, a resist material may be applied to a substrate by a suitable coating method such as spin coating, casting or roll coating, and heated on a hot plate, preferably at 60 to 200° C. for 10 seconds to 10 minutes, more preferably at 80 to 150° C. ° C. for 30 seconds to 5 minutes.

Then, the resulting film may be selectively exposed to radiation through a desired mask. The radiation used for exposure can be selected from ultraviolet ray, deep ultraviolet ray, X-ray and electron beam as needed, depending on the radiation-sensitive polymer composition to be used. The composition of the invention may be most suited for micro-patterning by excimer laser such as KrF of 248 nm or ArF of 193 nm. The exposure condition such as exposure dose may be selected as needed, depending on the component or kind of each additive comprised by the composition of the invention.

After the exposure, an optional heat treatment may be carried out, for example, on a hot plate preferably at 60 to 150° C. for 10 seconds to 5 minutes, more preferably at 80 to 130° C. for 30 seconds to 3 minutes. This heat treatment may be carried out, for example, when leaving of the acid-dissociable group hardly occurs without heat treatment so that sufficient resolution cannot be attained.

The resist film may be then subjected to a developer. In this case, an organic type aqueous alkali solution such as tetramethylammonium hydroxide (TMAH), or an inorganic type aqueous alkali solution such as sodium hydroxide, potassium hydroxide or potassium metaborate can be used.

According to the process of the invention, it is possible to obtain a radiation sensitive polymer composition which is effectively sensitive to radiation such as deep ultraviolet ray, exhibits particularly excellent sensitivity and resolution upon pattern formation using radiation having a wavelength of from 170 to 300 nm, and has excellent dry etching resistance. When the resist material of the invention having such characteristics is used, micro-patterns can be formed easily by the exposure particularly to KrF excimer laser or ArF excimer laser. It is therefore suited as a material for micro-pattern processing.

The invention will hereinafter be described in detail by synthesis examples, examples and comparative examples. However, it should not be construed that the invention is limited thereto.

### SYNTHESIS EXAMPLE 1

In a three-necked flask equipped with a stirrer, a reflux condenser and a thermometer, 18.5 g of a silane compound represented by formula (A) below, 5.8 g of a silane compound represented by formula (B) below, 190 g of tetrahydrofuran (THF), 95 g of water and 0.22 g of acetic acid were charged. While stirring, they were reacted at 30° C. for 17 hours. After the organic solvent was evaporated off, acetic acid (200 ml) was added. The mixture was neutralized with ammonia water and then washed with water. Until the reaction mixture became neutral, washing with water was repeated. The polymer was obtained after removal of the organic phase under reduced pressure, placed in a flask, and then heated at 170° C. for 14 hours. Consequently, a polymer (15.1 g) having a weight-average molecular weight (Mw) of 2600 was obtained.

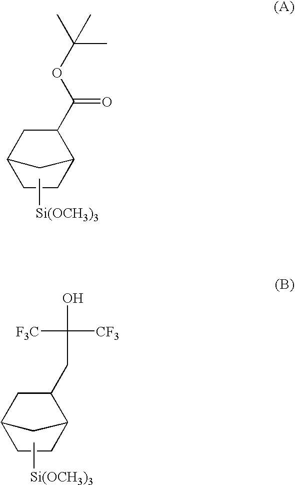

### SYNTHESIS EXAMPLE 2 to 7 AND COMPARATIVE EXAMPLES 1 to 4

In Synthesis Examples 2 to 7 and Comparative Examples 1 to 4, reactions and post treatments were carried out under conditions as shown in Table 1 in a similar manner to those in Synthesis Example 1 by using the silane compound, solvent and catalyst as shown in Table 1. Consequently, the polysiloxane compounds were obtained.

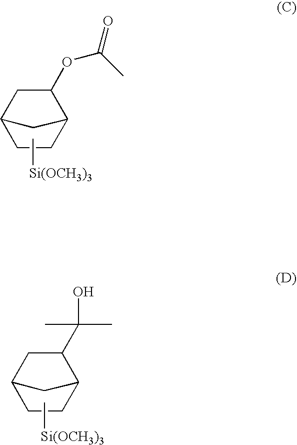

TABLE 1

| | compound (g) | | | | | | | | | | | | |
|---|---|---|---|---|---|---|---|---|---|---|---|---|---|
| | A | B | C | D | THF (g) | water (g) | catalyst (g) | temp. (° C.) | time | temp. (° C.) | time | Mw | yield (g) |
| Syn. | 16.7 | 2.3 | — | — | 150 | 75 | CH₃COOH | 30 | 17 | 170 | 14 | 2300 | 11.1 |
| Ex. 2 | | | | | | | (0.18) | | | | | | |
| Syn. | 13.3 | 5.6 | — | — | 150 | 75 | CH₃COOH | 30 | 17 | 170 | 14 | 2600 | 11.6 |
| Ex. 3 | | | | | | | (0.17) | | | | | | |
| Comp. | 12.2 | 6.6 | — | — | 150 | 75 | CH₃COOH | 30 | 17 | 170 | 14 | 2600 | 11.8 |
| Ex. 1 | | | | | | | (0.17) | | | | | | |
| Comp. | 10.4 | 13.0 | — | — | 190 | 95 | CH₃COOH | 30 | 17 | 170 | 14 | 3000 | 13.0 |
| Ex. 2 | | | | | | | (0.20) | | | | | | |
| Syn. | 2.4 | 3.7 | 6.6 | — | 100 | 50 | (COOH)₂ | 35 | 10 | 170 | 14 | 3100 | 7.2 |
| Ex. 4 | | | | | | | (0.10) | | | | | | |
| Syn. | 6.3 | 3.2 | 3.3 | — | 100 | 50 | CH₃COOH | 30 | 17 | 170 | 14 | 3200 | 8.1 |
| Ex. 5 | | | | | | | (0.12) | | | | | | |
| Syn. | 6.3 | 1.6 | 4.4 | — | 100 | 50 | CH₃COOH | 30 | 17 | 170 | 14 | 2800 | 7.1 |
| Ex. 6 | | | | | | | (0.12) | | | | | | |
| Syn. | 4.8 | 0.6 | 3.8 | 1.6 | 100 | 50 | (COOH)₂ | 35 | 10 | 170 | 14 | 2900 | 5.8 |
| Ex. 7 | | | | | | | (0.09) | | | | | | |
| Comp. | 1.5 | 0.4 | 11.3 | — | 100 | 50 | (COOH)₂ | 35 | 10 | 170 | 14 | 2400 | 8.2 |
| Ex. 3 | | | | | | | (0.11) | | | | | | |
| Comp. | 5.7 | — | — | 7.4 | 100 | 50 | (COOH)₂ | 35 | 10 | 170 | 14 | 2800 | 7.8 |
| Ex. 4 | | | | | | | (0.11) | | | | | | |

### EVALUATION EXAMPLE 1

After 100 parts by weight of the polysiloxane obtained in each of Synthesis Examples and Comparative Examples, 2.0 parts by weight of an acid generator represented by PAG-1, 0.2 part by weight of triethanolamine, and 0.1 part by weight of “X-70-093” (surfactant, product of Shin-Etsu Chemical Co., Ltd.) were dissolved in 900 parts by weight of propylene glycol monomethyl ether acetate, the resulting solution was filtered through a filter having a pore size of 0.2 μm, whereby a coating solution for forming positive type resist film was prepared. Then, the resist solution was applied to a silicon wafer by spin coating, baked at 110° C. for 90 seconds to prepare a resist film having thickness of 200 nm. By using the resulting wafer, dry etching was carried out and a difference in the thickness of the resist film before and after etching was determined. The test was conducted using a dry etching apparatus “TE-8500P” (product of Tokyo Electron Co., Ltd.) under the conditions of chamber pressure of 60 Pa, RF power of 600 W, Ar gas flow rate of 40 ml/min, O₂ gas flow rate of 60 ml/min, gap of 9 mm and etching time of 60 seconds. The results are shown in Table 2.

The acid generators in Table 2 and Table 3 are as follows:
PAG-1: triphenylsulfonium nonafluoro-n-butanesulfonate

PAG-2: diphenyliodonium nonafluoro-n-butanesulfonate

TABLE 2

| | | | | | fluorine | |
|---|---|---|---|---|---|---|
| | acid | basic | | | content | etching |
| polymer | generator | compound | surfactant | solvent | in polymer | rate |
| (wt parts) | (wt pt) | (wt pt) | (wt pt) | (wt pt) | (wt pt) | (nm/min) |
| Comp. Ex. 1 | PAG-1 | triethanolamine | X-70-093 | PGMEA | 19.8 | 218 |
| (100) | (2.0) | (0.2) | (0.1) | (900) | | |
| Comp. Ex. 2 | PAG-1 | triethanolamine | X-70-093 | PGMEA | 12.7 | 113 |
| (100) | (2.0) | (0.2) | (0.1) | (900) | | |
| Syn. Ex. 3 | PAG-1 | triethanolamine | X-70-093 | PGMEA | 10.7 | 59 |
| (100) | (2.0) | (0.2) | (0.1) | (900) | | |
| Syn. Ex. 1 | PAG-1 | triethanolamine | X-70-093 | PGMEA | 8.7 | 32 |
| (100) | (2.0) | (0.2) | (0.1) | (900) | | |
| Syn. Ex. 2 | PAG-1 | triethanolamine | X-70-093 | PGMEA | 4.4 | 26 |
| (100) | (2.0) | (0.2) | (0.1) | (900) | | |

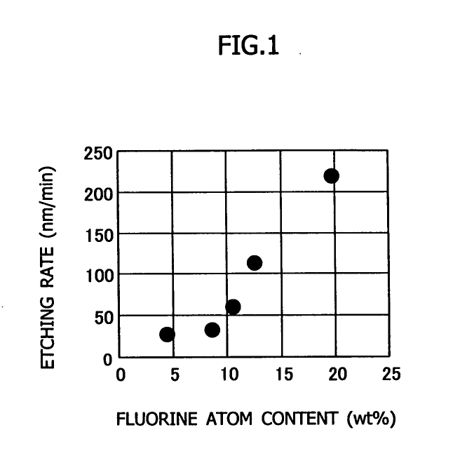

It is evident in Table 1 that the etching rate of the radiation-sensitive polymer composition of the invention increases as the content of the structural unit represented by formula (2) increases. In particular, good etching resistance can be maintained when a polymer having an average fluorine-atom content of not greater than 11 wt % is employed. The relationship between etching rate and fluorine atom content of each of the compositions obtained in Synthesis Examples 1 to 3 and Comparative Examples 1 to 2 is shown in FIG. 1.

### EVALUATION EXAMPLE 2

The polysiloxane obtained in each of Synthesis Examples and Comparative Examples, the acid generator, the basic compound and the surfactant shown in Table 3 were dissolved in propylene glycol monomethyl ether acetate. The resulting solution was filtered through a filter having a pore size of 0.2 μm to prepare a coating solution for forming positive type resist film. Then, the resist solution Was applied by a spin coater onto a film formed on silicon wafer, the film being of “DUV-30J” (product of Nissan Chemical Co., Ltd.) and having thickness of 55nm, and baked at 110° C. for 90 seconds. Consequently, a resist film having thickness of 200 nm was formed. This film was exposed to an ArF excimer laser stepper (product of Nikon Corp., NRS-S305B, NA=0.68, σ=0.85). After baked at 90° C. for 90 seconds, the film was developed for 60 seconds in a 2.38 wt % aqueous solution of tetramethylammonium hydroxide, whereby a positive pattern was obtained.

The resist pattern thus obtained was evaluated in the following manner.

Evaluation method: Supposing that the exposure dose which had provided a 1:1 resolution of a 0.18 μm line-and-space pattern was the optimum dose (Eop), the minimum line width (μm) of the lines and spaces being separated at the optimum dose (Eop) was defined as the resolution of the resist under evaluation. The results are as shown in Table 1. It has been found evident that the radiation sensitive polymer composition of the invention shows high resolution performance to ArF excimer laser. In the case of the composition containing the polymer obtained in Comparative Example 3 or 4, many residues remained in the exposed portion, leading to failure in resolution.

TABLE 3

| | | | | | | fluorine | |
|---|---|---|---|---|---|---|---|
| | acid | basic | | | | content | etching |
| polymer | generator | compound | surfactant | solvent | resolution | in polymer | rate |
| (wt pt) | (wt pt) | (wt pt) | (wt pt) | (wt pt) | (μm) | (wt pt) | (nm/min) |
| Syn. Ex. 1 | PAG-1 | triethanolamine | X-70-093 | PGMEA | 0.14 | 8.7 | 32 |
| (100) | (2.0) | (0.2) | (0.1) | (900) | | | |
| Syn. Ex. 4 | PAG-1 | tributylamine | X-70-093 | PGMEA | 0.13 | 10.8 | 45 |
| (100) | (2.0) | (0.3) | (0.1) | (900) | | | |
| Syn. Ex. 5 | PAG-2 | triethanolamine | X-70-093 | PGMEA | 0.14 | 9.2 | 39 |
| (100) | (3.0) | (0.2) | (0.1) | (900) | | | |
| Syn. Ex. 6 | PAG-1 | tributylamine | X-70-093 | PGMEA | 0.14 | 4.8 | 25 |
| (100) | (2.0) | (0.3) | (0.1) | (900) | | | |
| Syn. Ex. 7 | PAG-1 | triethanolamine | X-70-093 | PGMEA | 0.15 | 2.1 | 23 |
| (100) | (2.0) | (0.2) | (0.1) | (900) | | | |
| Comp. Ex. 3 | PAG-1 | tributylamine | X-70-093 | PGMEA | x | 1.2 | — |
| (100) | (2.0) | (0.3) | (0.1) | (900) | | | |
| Comp. Ex. 4 | PAG-1 | triethanolamine | X-70-093 | PGMEA | x | 0.0 | — |
| (100) | (2.0) | (0.2) | (0.1) | (900) | | | |

1. A radiation sensitive polymer composition comprising
(A) a polysiloxane compound
comprising at least one structural unit represented by formula (1) having an acid-dissociable group which leaves in the presence of an acid, and at least one structural unit represented by formula (2) comprising at least one fluorine atom,
being alkali insoluble or alkali sparingly soluble but becoming alkali soluble when the acid-dissociable group leaves, and
having an average fluorine atom content of more than 2 wt % but not more than 11 wt %;
(B) an acid generator, and
(C) a basic compound
wherein the formulas (1) and (2) are represented by: 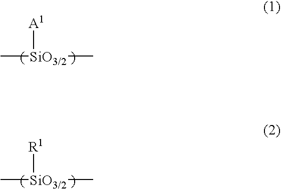
wherein A¹ represents a monovalent organic group comprising an acid-dissociable group which leaves in the presence of an acid; and R¹ represents a linear, branched or cyclic C₁₋₂₀ alkyl group comprising at least one fluorine atom, or a linear, branched or cyclic halogenated C₁₋₂₀ alkyl group comprising at least one fluorine atom and at least one halogen atom other than the fluorine atom.

2. The radiation sensitive polymer composition according to claim 1, wherein the structural unit represented by the formula (1) or (2) is represented by formula (3) or (4), respectively, 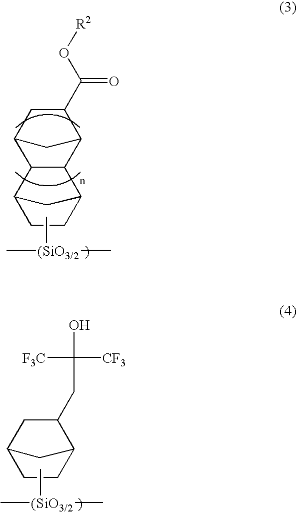
wherein R² represents an acid-dissociable group and n stands for an integer of 0 or 1.

3. The radiation sensitive polymer composition according to claim 1, wherein the structural unit represented by the formula (2) is represented by formula (4):

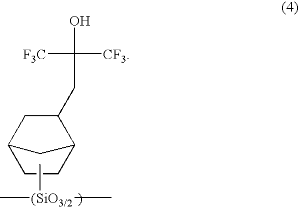

4. The radiation sensitive polymer composition according to claim 2, wherein the structural unit represented by the formula (2) is represented by formula (4):

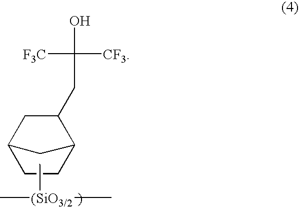

5. A process for forming a resist pattern, comprising steps of:
applying the radiation sensitive polymer composition according to claim 1 onto a substrate to form a film,
heating the film,
exposing the heated film to radiation having a wavelength of from 170 to 300 nm through a photomask,
optionally heating the exposed film, and
developing the film with a developer.

6. A process for forming a resist pattern, comprising steps of:
applying the radiation sensitive polymer composition according to claim 2 onto a substrate to form a film,
heating the film,
exposing the heated film to radiation having a wavelength of from 170 to 300 nm through a photomask,
optionally heating the exposed film, and
developing the film with a developer.

7. A process for forming a resist pattern, comprising steps of:
applying the radiation sensitive polymer composition according to claim 3 onto a substrate to form a film,
heating the film,
exposing the heated film to radiation having a wavelength of from 170 to 300 nm through a photomask,
optionally heating the exposed film, and
developing the film with a developer.

8. A process for forming a resist pattern, comprising steps of:
applying the radiation sensitive polymer composition according to claim 4 onto a substrate to form a film,
heating the film,
exposing the heated film to radiation having a wavelength of from 170 to 300 nm through a photomask,
optionally heating the exposed film, and
developing the film with a developer.
